(19) United States
(12) Patent Application Publication
(10) Pub. No.: US 2013/0234863 A1
(43) Pub. Date: Sep. 12, 2013

(54) METHOD AND APPARATUS FOR MOBILE METERING

(71) Applicant: TRILLIANT NETWORKS, INC., Redwood City, CA (US)

(72) Inventors: Remko Vos, San Mateo, CA (US); Sudhir Srinivas, Fremont, CA (US); Claudine Berard, Farnham (CA)

(73) Assignee: TRILLIANT NETWORKS, INC., Redwood City, CA (US)

(21) Appl. No.: 13/790,977

(22) Filed: Mar. 8, 2013

Related U.S. Application Data
(60) Provisional application No. 61/608,461, filed on Mar. 8, 2012.

(51) Int. Cl. G08C 19/00

(52) U.S. Cl. CPC G08C 19/00
USPC 340/870.03

(57) ABSTRACT

A system for mobile metering. The system comprises a plurality of white space meters, wherein the white space meters are not connected to a network and are communicatively coupled to each other, wherein a white space meter within the plurality of white space meters is designated a collector; and a field device connected to a mobile communication device for accessing at least one white space meter in the plurality of white space meters in order to perform at least one task, wherein the field device comprises a task list, the task list comprising the at least one task to be performed on at least one white space meter.

### CROSS-REFERENCE TO RELATED APPLICATIONS

This application claims priority to U.S. Provisional Patent Application Ser. No. 61/608,461 filed Mar. 8, 2012, which is incorporated by reference herein in its entirety.

### BACKGROUND OF THE INVENTION

1. Field of the Invention

Embodiments of the present invention generally related to meter reading and maintenance and, more particularly, to a method and apparatus for mobile metering.

2. Description of the Related Art

In the utility delivery space, there have been numerous advances in technology with respect to efforts to provide improved methods and systems for monitoring and controlling the delivery and use of a commodity by various utilities (e.g., electricity, water, gas, etc). By way of specific example, smart grid systems, including advanced metering infrastructures (“AMIs”) and the like have been developed that incorporate smart meters or existing meters retrofitted with modules that include at least a radio, configurable microprocessor, and storage capacity. These meters are configured to communicate using predetermined protocols with other nodes such as other meters and WAN/NAN access points (i.e., collectors, bridges, mesh gates) in the smart grid across what is commonly referred to as a neighborhood area network (“NAN”).

A smart grid system may be employed to monitor commodity delivery by a utility, such as by reporting meter readings of commodity delivery to back-end systems. For example, meters within the smart grid may determine if delivery of power is occurring or if there is a power outage, and may report power readings or an outage condition to the back-end server. A more detailed description of an exemplary smart grid system configuration and the various communications processes implemented across the smart grid are described in at least U.S. patent application Ser. No. 12/554,135, titled “System and Method for Implementing Mesh Network Communications Using a Mesh Network Protocol,” published Mar. 11, 2010, which is commonly assigned and incorporated herein by reference in its entirety.

In some rural areas, deployment of a full mesh network system is not cost effective, as mesh devices may be located at extreme distances from each other and may not be able to use a fixed communication point to access a back-end server. Nevertheless, regulators may require utilities to extend the same level of service, including time-of-use billing and access to usage information, to customers in these remote areas as they do to customers in more urban areas who do have a fixed communication point to access the back-end server. Additionally, it is desirable that meters in such remote areas, referred to herein as “white space meters” provide the same diagnostic and maintenance capabilities as meters that are in more urban areas.

Currently, in order to read white space meters, a mobile device is required to connect with each white space meter to perform meter reads. This is inefficient and often difficult do to the remote locations typically associated with the white space meters.

There is thus a need in the art for methods and systems allowing the deployment of mesh network systems in ultra rural areas at acceptable costs. Such systems should provide support for a full spectrum of meter management functions including but not limited to meter reads, meter maintenance and mesh network communication diagnostics. Such systems and methods should have the ability to read individual meters as well as small clusters of meters and should be adapted to be mobile or otherwise capable of being transported across potentially large distances.

### SUMMARY OF THE INVENTION

A method and apparatus for mobile metering substantially as shown in and/or described in connection with at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE FIGURES

FIG. 1 depicts an environment comprising white space meters, according to some embodiments of the invention;

FIG. 2 depicts a system for performing mobile metering according to some embodiments of the invention; and

FIG. 3 depicts a flow diagram of a method for mobile metering as performed by the drive-by meter application of FIG. 1, according to some embodiments of the invention.

While the method and apparatus is described herein by way of example for several embodiments and illustrative drawings, those skilled in the art will recognize that the method and apparatus for mobile metering is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the method and apparatus for mobile metering defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to. As used herein, the words “process”, “processed” or “processing” are not meant to be limiting and are used to describe any modification or manipulation of digital content including, but not limited to converting digital content from a first format to a second format, merging digital content from a plurality of sources into a single target, copying, cutting or pasting digital content from a first file to a second file, and the like. Additionally, the words “meter read data” include not only usage data read by a meter, but also other data, such as diagnostic and maintenance data, by way of non-limiting example.

### DETAILED DESCRIPTION OF EMBODIMENTS

Embodiments of the present invention comprise a mobile metering tool, hereafter referred to as a field device that acts as a mobile access point for a local mesh network comprised of white space meters. Due to the geographic location of the white space meters, they are unable to connect to a network, however, the white space meters are able to connect with other white space meters that are within range. The field device may therefore, connect with a single white space meter and route instructions through the single white space meter to the other white space meters, in order to perform tasks on the other white space meters that are within range of the single white space meter. All data collected in response to the task is stored on the field device. When all tasks are completed for the white space meters in the local mesh network, the field device may be brought to a second group of white space meters (i.e., a second local mesh network) and while connected to one white space meter in the group, perform tasks on one or more white space meters in the group. If all tasks are complete on all white space meters, the field device may be brought within range of a neighborhood access network (NAN), where it may transmit the data through the network to a server, or the field device may be brought to the server and transmit the data directly to the server.

The embodiments provide for the field device receiving a task list comprising at least one task that is to be performed on at least one white space meter. A white space meter is a meter that cannot access a network because of its geographic distance from the network. A task list may comprise an item to perform, for example, a meter read on meter ABC and a meter read on meter XYZ. Prior to performing the tasks on the task list, the field device application performs a clock synchronization on the field device. Clock synchronization may be performed using any clock synchronization known in the art, such as network time protocol (NTP). In addition to meter reads, tasks may include a clock synchronization on the meter, a firmware upgrade, a configuration upgrade, a key update, a diagnostic check, and the like. As each task is performed, the success or failure of the task is recorded on the field device. A clock sync task is automatically performed on each meter after a meter read is performed. However, if a meter is not scheduled for a meter read, a clock sync task may be on the task list for the meter in order for the field device to synchronize the meter's clock.

After performing tasks on a specific meter, a user of the field device may optionally add notes regarding the meter that may be useful at the time a task is performed on the meter in the future. For example, a note may be added to “beware of the dog” or provide assistance with finding the location of the meter. All of the tasks for a particular meter are performed before the field device performs tasks on a next meter.

Although white space meters are geographically remote and cannot connect to a network, the white space meters that are within range of one another can communicate with each other and route and share data through and among one another. For example, a group of white space meters may be located on a mountain, with a first white space meter near a roadway and additional white space meters further up the mountain. It may not be difficult to drive the field device to the first white space meter, however access to the white space meters further up the mountain may only be reachable on foot. Because the white space meters create a local mesh network, the meters further up the mountain are able to route data through the other white space meters on the mountain and down to the first white space meter near the roadway, where the data may then be transmitted to and stored on the field device. The white space meters may be considered nodes of a local mesh network, wherein the meters are configured to route data between nodes within the local mesh, and the field device may be thought of as a mobile access point that collects the data from the local mesh network and transports it within range of a network that can transfer the data to a server.

In some embodiments, a collector is located in an accessible location where it is within range of one white space meter in a group of white space meters (i.e., a local mesh network). The collector may routinely store meter read data from all of the white space meters within the local mesh. A collector may be a dedicated hub or it may be any designated white space meter within the local mesh. When a field device is within range of the collector, the field device may collect the meter read data and store the data on the field device.

In some embodiments, where the collector is a white space meter within the local mesh, the field device may then connect to the collector and query the collector in order to determine what other white space meters can be reached through the collector. In response to the query, a list of white space meters may be displayed on the field device. A white space meter may be selected from the list. The field device may then send information through the collector to perform a task on the selected white space meter. If the collector is within range of the selected white space meter, the collector sends the information directly to the white space meter and receives status information or data resulting from the task. In the event that the collector is not within range of the selected white space meter, the information is routed through the local mesh network until it reaches the selected white space meter. The status information or data resulting from the task is routed back through the local mesh network to the collector, where it may be read directly by the field device. All tasks for the white space meters connected to the collector may be performed through the collector.

The field device may then move to a next group of white space meters that make up their own local mesh network to perform tasks in the next group through a collector for the next group.

When all tasks on the task list are completed for all meters on the task list, the field device uploads the data to a server. The data may include the meter read data, the success or failure of each task, any notes added regarding the meter, and the like.

In one embodiment, a mobile metering tool may be employed in a disaster recovery scenario. For example, the tool may be used to read meters that would normally report meter information via a mesh network node, but that are temporarily not able to do so (e.g., due to a network problem). The metering tool may thus be employed as an “insurance” policy to allow utilities to read meters even when there is a problem, such as, when the communication network is inoperative.

In yet another embodiment, the mobile metering tool may support field operations to diagnose meter and/or communication issues.

The inventive systems and methods described herein may provide support for a full spectrum of meter management functions, including but not limited to meter reads, meter maintenance, and/or mesh network communication diagnostics. In certain embodiments, an inventive mobile metering tool may be configured to read individual meters and/or a cluster of meters.

Various embodiments of a method and apparatus for mobile metering are described. In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description that follow are presented in terms of algorithms or symbolic representations of operations on binary digital signals stored within a memory of a specific apparatus or special purpose computing device or platform. In the context of this particular specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

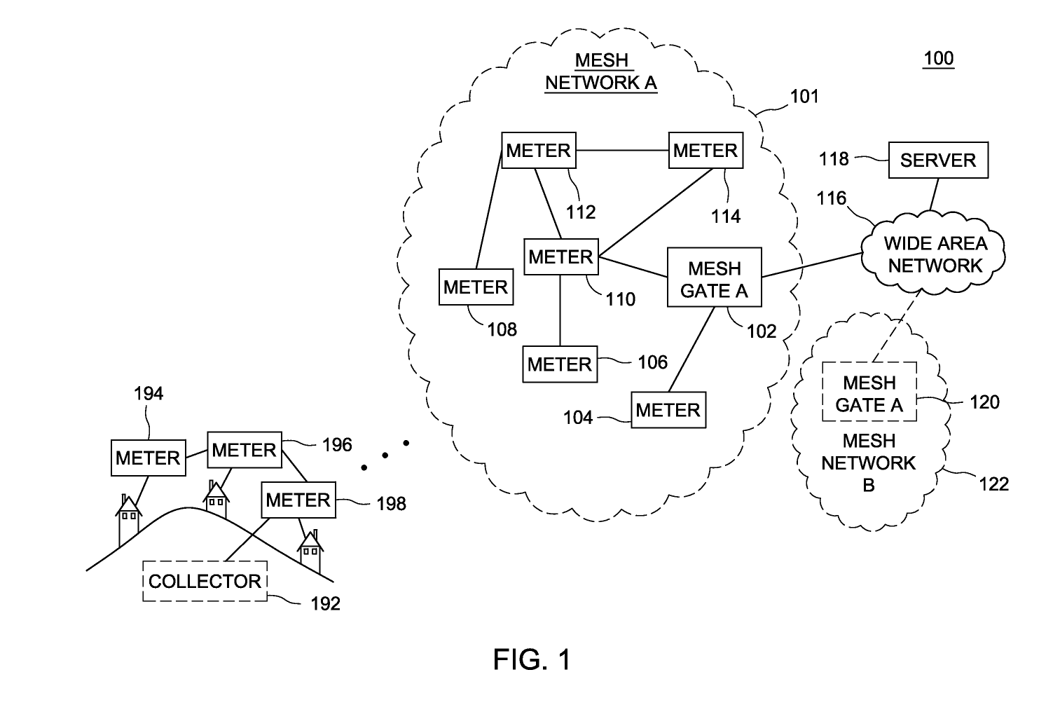

FIG. 1 depicts an environment 100 comprising white space meters, according to some embodiments of the invention. The environment 100 comprises a mesh network A 101. Mesh network A 101 may include a mesh gate A 102 and a plurality of meters 104, 106, 108, 110, 112, and 114. A mesh gate may also be referred to as a NAN-WAN gate or an access point. The mesh gate A 102 may communicate with a server 118 over a wide area network (WAN) 116. Optionally, a mesh gate B 120 and a mesh network B 122 may also communicate with the server over the WAN 116. In one exemplary embodiment, the server 118 is known as a “head end server” (HES). The meters 104, 106, 108, 110, 112, and 114 may communicate with the mesh gate A 102 directly or through other meters within the mesh network A 101.

Meters 194, 196, 198 are a group of meters referred to as a white space meters. Meters 194, 196, 198 are located in a geographic location that does not have access to a mesh network (i.e., in white space) and therefore cannot connect with a mesh gate to reach the server 118. In some embodiments, a collector 192 is within range of one or more of the white space meters 194, 196, 198. The collector 192 collects meter read data for the group of white space meters. In some embodiments, the collector 192 is a meter within the group of white space meters. The white space meters 194, 196, and 198 act as a local mesh network. Each meter 194, 196, 198 within the group of white space meters is within range of at least one other meter in the local mesh and data may be routed through a white space meter in order to read another white space meter within range. A field device may collect data and perform maintenance on the group of meters by accessing the collector and routing all information through the collector to the other meters in the group of meters (i.e., local mesh).

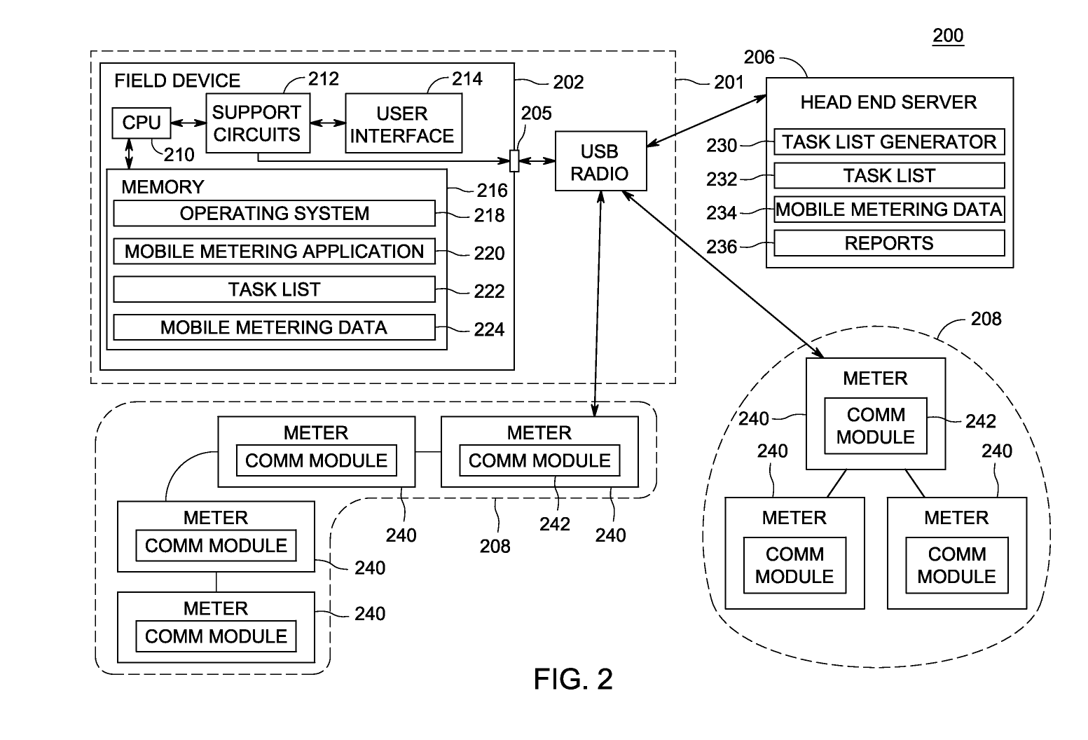

FIG. 2 is a block diagram of a system 200 for mobile metering, according to one or more embodiments. The system 200 comprises a mobile communication device 201 including a field device 202 and a Universal Serial Bus (USB) radio 204 connected to the field device 202, as well as a server 206, and one or more meters 208. USB radio 204 provides bi-directional communication capability.

The field device 202 is a type of computing device (e.g., a Personal Digital Assistant (PDA), a tablet, a Smartphone, and or the like), capable of connecting to the USB radio 204 via a USB connector 205 of the field device 202. The field device comprises a CPU 210, support circuits 212, a user-interface 214, and a memory 216. The memory comprises an operating system 218, a mobile metering application 220, a task list 222, and mobile metering data 224. The CPU 210 may comprise one or more commercially available microprocessors or microcontrollers that facilitate data processing and storage. The various support circuits 212 facilitate the operation of the CPU 210 and include one or more clock circuits, power supplies, cache, input/output circuits, displays, and the like. The support circuits 212 are connected to the USB connector 205 for supporting devices connected to the USB connector 205. The memory 216 comprises at least one of Read Only Memory (ROM), Random Access Memory (RAM), disk drive storage, optical storage, removable storage and/or the like.

The operating system 218 generally manages various computer resources (e.g., network resources, file processors, and/or the like). The operating system 216 is configured to execute operations on one or more hardware and/or software modules, such as Network Interface Cards (NICs), hard disks, virtualization layers, firewalls and/or the like.

The head end server (HES) 206 is a type of computing device (e.g., a laptop, a desktop, and/or the like). The HES 206 comprises a task list generator 230, a task list 232, received mobile metering data 234, and reports 234. In certain embodiments, the HES 206 may be a central processing system including one or more computing systems (i.e., one or more server computers).

Each meter in the plurality of meters 208 comprises a communication module 228. Each meter in the plurality of meters is at least one of a smart meter or an existing meter retrofitted with modules that include at least a radio, configurable microprocessor and storage capacity. These meters are configured to communicate using predetermined protocols with other nodes such as other meters and WAN/NAN access points (i.e., collectors, bridges, mesh gates) in the smart grid across what is commonly referred to as a neighborhood area network (“NAN”). However, some of the meters 208 may be white space meters, meaning the meters are located in remote locations where traditional secure mesh communication across the NAN via communication module 228 is not possible (due to their remote location).

In such situations, the field device 202 is used in combination with the USB radio 204 or other external antenna, which may be attached to the field device 202 via the USB connector 205, to provide communication between white space meters and the smart grid system. More specifically, together with the mobile metering application 220 installed on the field device 202, the USB radio 204 provides connectivity between the field device 202 and groups of white space meters 208 which are located in remote locations. White space meters 208 are in a group if there is a path through which data may be routed such that each white space meter 240 can be reached, thus making each group of white space meters 208 a local mesh network.

In some embodiments, a white space meter 240 within a group of white space meters (i.e., the local mesh network) 208 may be designated as a collector. In other embodiments, any white space meter within the group of white space meters 208 may be dynamically selected to be the collector. The collector 240 is the white space meter within the group of white space meters (i.e., the local mesh network) 208 that communicates directly with the mobile metering application 220 via the communication module 242. Thus, via the field device 202, the mobile metering application 220 communicates with the communication module 242 within the group of meters (i.e., the local mesh network) 208 in order to perform tasks. In some embodiments, USB radio 204 provides bi-directional communication with the white space meters 240. The field device 202 is able to communicate with many different types of meters 240, including but not limited to energy-only, demand, and/or interval meters.

In some embodiments, the field device 202 may be in communication with a Global Positioning System (GPS) module (not shown), which may be either integral or separate to an automobile or integral with the field device 202. Using the GPS module, the field device 202 may capture the GPS location from which a meter 208 is read at the time of meter data collection and may store and later upload such information to the HES 206.

The HES 206 is configured to generate a task list 232 of meters 208 that must be visited for meter reads, diagnostic or meter maintenance purposes (e.g., firmware upgrades and/or configuration changes). The task list 232 comprises at least one meter 208 to be visited and one or more tasks that must be performed on the meter 208. The HES 206 is configured to transmit the task list 232 to the field device 206 via the USB radio 204. In some embodiments, the list of meters to be read may be provided by a billing system (not shown) based on a determination of, for example, a customer's billing cycle.

In one embodiment, the field device 202 may download meter-reading orders, and the clock of the field device 202 may be automatically synchronized with the network time. The field device 202 may be synchronized to an accurate and common time source (e.g., a network time protocol (NTP)).

The field device 202 may be used by a field operator to perform the tasks on the task list 222 scheduled on a specific day. Generally, the field device 202 may interact with a single meter 208 or a group of meters 208 to collect meter-reading reports via the USB radio 204. In one embodiment, the field device 202 may be programmed to collect all or a subset of reports from a meter 208. For example, the field device 202 may retrieve only new data since a last read or may retrieve all meter reads stored on a given meter 208. The field device 202 may also be used to force/reset reports and clear the status of a meter 208.

In certain embodiments, the field device 202 may maintain a full audit trail of meter reads and maintenance, including which reports have been downloaded, whether the download was successful or failed and, if the download failed, any error messages associated with the download. A full audit trail of all the meter interaction, including error messages and log files, and such information may be synchronized with the HES 206 each time the field device 202 is synchronized with the HES 206.

In one embodiment, the field device 202 may be able to perform one or more meter maintenance tasks required, including but not limited to, clock synchronization, firmware upgrades and/or configuration updates. For example, certain regulations require a meter clock to remain within 90 seconds of network time, and the tool may reset the clock to the appropriate network time each time the meter 208 is read. In addition, if a clock drift/error is detected, the field device 202 may record a note for the meter 208 such as “clock drift detected.”

Considering that the field device 202 may support meter reads as well as meter maintenance, and that the two areas may be supported by different people, the user interface (UI) of field device 202 may be intuitive and can be manipulated in such a way that only the relevant operations and data are available to a particular user. Moreover, the field device 202 may be able to cycle through its operations with minimal user interference under normal circumstances.

Once meter reports are collected, the field device 202 may be used to upload the mobile metering data 224 to the HES 206, either wirelessly via USB radio 208 or via a wired connection using the USB connector 205.

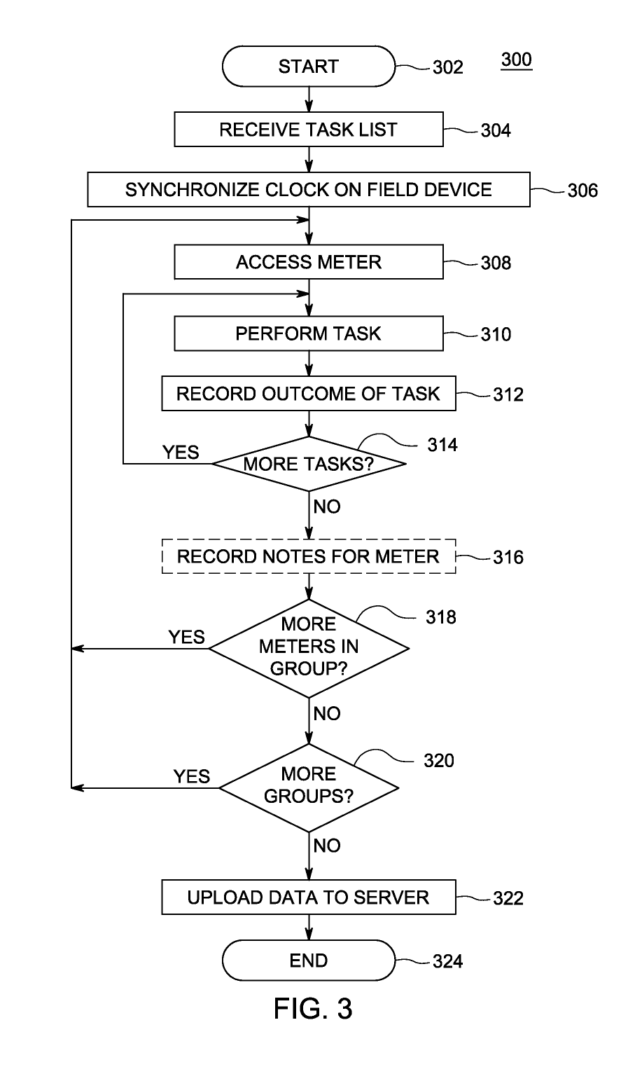

FIG. 3 depicts a flow diagram of a method 300 for mobile metering as performed by the mobile metering application 220 of FIG. 2, according to one or more embodiments. The method 300 receives a task list, accesses each meter on the task list, either directly or indirectly, in order to perform the specified task, and uploads the data generated from performing the tasks on the task list.

The method 300 starts at step 302 and proceeds to step 304. At step 304, the method 300 receives a task list. The task list is a list of meters that need to be visited and one or more tasks that must be performed on the meter during the visit. The tasks include meter reading, firmware upgrades, configuration updates, key updates, clock synchronization, diagnostics, and the like. Location information for a meter as well as driving instructions may be included with the task. In addition, notes may be included with a task regarding specific information about the meter, for example, “Beware of the dog.” In some embodiments, the meter reading tasks are generated separate from the meter management tasks and the tasks are combined into a task list before the task list is received by method 300.

The method 300 proceeds to step 306, where the method 300 synchronizes the clock on a field device that is performing the method 300. The clock is synchronized with the network using clock synchronization known in the art, for example NTP. The clock on the field device is synchronized with the network so the field device can then synchronize a clock on a meter, should the clock sync task be required.

The method 300 proceeds to step 308, where the method 300 accesses a first meter on the task list. The first meter on the task list may not be within range of the field device. However, another meter within the group of meters (i.e., the local mesh network) may be within range of the field device. The meter within range of the field device is hereafter referred to as the collector. The method 300 sends instructions to the collector to perform a task on the task list. The method 300 uses a USB transceiver attached to the field device to connect to the collector. The collector routes the instructions through the local mesh network of white space meters to the first meter on the task list.

The method 300 proceeds to step 310, where the method 300 performs the task on the task list. The task may be a meter read task, a clock sync task, a firmware upgrade task, a configuration upgrade task, a key update task, a diagnostic task, and the like.

If the task is a meter read task, the method 300 accesses information contained within the task to determine whether to collect all or a subset of commodity usage from the meter. For example, the method 300 may retrieve only new data since a last meter read or may retrieve all meter reads stored on the given meter. If the task includes instructions to force/reset reports and clear the status of a meter, the method 300 executes these instructions as well.

After the method 300 performs the meter read task, the method 300 automatically performs a clock sync task to synchronize the clock on the meter with the network time as known by the clock of the field device. The clock of the field device was synchronized with the network in step 306 above.

If the task is a firmware upgrade task, the task information contains a firmware image. The method 300 transmits the new firmware image to the meter. If the task is a configuration upgrade task, the task information contains a configuration file to execute against the meter network interface card (NIC). The configuration file contains changes to any device parameters that are to be modified. The method 300 transmits the configuration file to the meter where it is executed on the meter. If the task is a key update task, the task information contains a new security key for the meter, which the method 300 transmits to the meter.

The tasks discussed here are not meant to be limiting. Other embodiments of the present disclosure envision additional possible tasks that may be performed on the meter.

The method 300 proceeds to step 312, where the method 300 records the outcome of the task. The method 300 routes data resulting from the task back to the collector where it may be transmitted to and stored on the field device. The method 300 stores the meter read data, as well as the success or failure of the tasks or instructions. In the event of a failure, the method 300 records any error messages received during execution of the task.

The method 300 proceeds to step 314, where the method 300 determines whether there are any more tasks to be performed on the meter. If additional tasks must be performed on the meter, the method 300 proceeds to step 310, where the method 300 iterates until at step 314, the method 300 determines that all tasks have been performed on the meter, at which time the method 300 proceeds to step 316.

Optionally, at step 316, notes for the meter may be recorded. The method 300 provides a user interface where a user of the field device may enter notes regarding the meter. Notes may include, for example, a clarification of directions, a warning about an animal on the premises, and the like.

The method 300 proceeds to step 318, where the method 300 determines whether there are any more meters within the local mesh network on which to perform tasks, on the task list. If the method 300 determines there are more meters, the method 300 proceeds to step 308 and iterates until all tasks for all meters within the local mesh network have been performed at which time the method 300 proceeds to step 320.

At step 320, the method 300 determines whether there any other groups of meters on which to perform tasks. If there are, the method 300 proceeds to step 308 and iterates through all of the meters in a next group of meters. However, is the method 300 determines that all tasks on the task list have been performed for all meters on the task list, the method 300 proceeds to step 322.

At step 322, the method 300 uploads all of the mobile metering data collected from performing the tasks to a server, where it may be used for reporting, etc. The method 300 proceeds to step 324 and ends.

The exemplary embodiments can relate to an apparatus for performing one or more of the functions described herein. This apparatus may be specially constructed for the required purposes, or it may comprise a general-purpose computer selectively activated or reconfigured by a computer program stored in the computer. Such a computer program may be stored in a machine (e.g., computer) readable storage medium, such as, but is not limited to, any type of disk including floppy disks, optical disks, CD-ROMs and magnetic-optical disks, read only memories (ROMs), random access memories (RAMs) erasable programmable ROMs (EPROMs), electrically erasable programmable ROMs (EEPROMs), magnetic or optical cards, or any type of media suitable for storing electronic instructions, and each coupled to a bus.

Some exemplary embodiments described herein are described as software executed on at least one processor, though it is understood that embodiments can be configured in other ways and retain functionality. The embodiments can be implemented on known devices such as a server, a personal computer, a special purpose computer, a programmed microprocessor or microcontroller and peripheral integrated circuit element(s), and ASIC or other integrated circuit, a digital signal processor, a hard-wired electronic or logic circuit such as a discrete element circuit, or the like. In general, any device capable of implementing the processes described herein can be used to implement the systems and techniques according to this invention.

It is to be appreciated that the various components of the technology can be located at distant portions of a distributed network and/or the internet, or within a dedicated secure, unsecured and/or encrypted system. Thus, it should be appreciated that the components of the system can be combined into one or more devices or co-located on a particular node of a distributed network, such as a telecommunications network. As will be appreciated from the description, and for reasons of computational efficiency, the components of the system can be arranged at any location within a distributed network without affecting the operation of the system. Moreover, the components could be embedded in a dedicated machine.

Furthermore, it should be appreciated that the various links connecting the elements for communication can be wired or wireless links, or any combination thereof, or any other known or later developed element(s) that is capable of supplying and/or communicating data to and from the connected elements. The terms determine, calculate and compute, and variations thereof, as used herein are used interchangeably and include any type of methodology, process, mathematical operation or technique.

The invention described and claimed herein is not to be limited in scope by the specific embodiments herein disclosed since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims. All publications cited herein are incorporated by reference in their entirety.

1. A system for mobile metering comprising:
a plurality of white space meters, wherein the white space meters are not connected to a network and are communicatively coupled to each other, wherein a white space meter within the plurality of white space meters is designated a collector; and
a field device connected to a mobile communication device for accessing at least one white space meter in the plurality of white space meters in order to perform at least one task, wherein the field device comprises a task list, the task list comprising the at least one task to be performed on at least one white space meter.

2. The system of claim 1, wherein the field device accesses the plurality of white space meters through the collector.

3. The system of claim 1, further comprising a head end system for generating a task list comprising tasks to perform on one or more white space meters in the plurality of white space meters and receiving data from the field device responsive to performance of the at least one task.

4. The system of claim 1, wherein the white space meters in the plurality of white space meters comprise a local mesh network, wherein data may be routed through the local mesh network from the collector to a different white space meter in the plurality of white space meters.

5. The system of claim 1, wherein the field device collects data in response to the performed tasks and transmits the data to the head end system when the field device moves within range of the head end system.

6. The system of claim 4, wherein the field device accesses the plurality of white space meters through the collector.

7. A computer implemented method for mobile metering comprising:
receiving a task list on a mobile programmable field device connected to a mobile communication device for accessing at least one white space meter within a local mesh network, wherein the task list comprises at least one task to perform on the at least one white space meter;
accessing the white space meter on which to perform the at least one task through a designated collector within the local mesh network, wherein a white space meter within the plurality of white space meters is designated the collector;
performing the at least one task on the white space meter;
routing data resulting from the performance of the at least one task to the collector;
transmitting the data from the collector to the mobile programmable field device; and
recording data regarding the at least one task on the mobile programmable field device.

8. The method of claim 7, further comprising uploading the recorded data from the mobile programmable field device to a server for reporting when the mobile programmable field device is within range of the server.

9. The method of claim 7, wherein a communication protocol of the mobile communication device is the same communication protocol used for accessing non-white space meters.

10. The method of claim 7, wherein the task comprises at least one of a meter read, a clock synchronization, a firmware upgrade, a key update or a configuration update.

11. The method of claim 7, wherein accessing comprises connecting from the field device to the meter via a Universal Serial Bus (USB) transceiver.

12. The method of claim 7, wherein the field device is programmed to perform bi-directional communication with the collector.

13. The method of claim 7, wherein a meter read task comprises at least one of new data since a last meter read or all meter reads stored on the meter.

14. An apparatus for mobile metering comprising:
a mobile programmable field device comprising;
a USB transceiver for facilitating communication between the field device and a collector, wherein the collector is a white space meter in a plurality of white space meters that are not connected to a network, and are communicatively connected to each other;
a mobile metering application for interacting via the USB transceiver with the collector in order to perform at least one task identified on a task list on a white space meter in the plurality of white space meters;
a memory to store information collected from the white space meter in the plurality of white space meters; and
wherein the mobile programmable field device is adapted to transmit the stored information to a server when the field device is within range of the server.

15. The apparatus of claim 14, wherein a communication protocol of the USB transceiver is the same communication protocol used for accessing non-white space meters, and wherein the communication between the field device and the at least one white space meter is bi-directional.

16. The apparatus of claim 14, wherein the task comprises at least one of a meter read, a clock synchronization, a firmware upgrade, a key update or a configuration update.

17. The apparatus of claim 14, wherein accessing comprises connecting from the field device to the meter via a Universal Serial Bus (USB) transceiver.

18. The apparatus of claim 14, wherein the recorded data comprises at least one of meter read data or the success or failure of the at least one task.

19. The apparatus of claim 16, wherein a meter read task comprises at least one of new data since a last meter read or all meter reads stored on the meter.
